(19) United States
(12) Patent Application Publication
(10) Pub. No.: US 2012/0192486 A1
(43) Pub. Date: Aug. 2, 2012

(54) LIGHT-EMITTING DIODE (LED) LIGHT BAR

(75) Inventors: David M. Shanahan, Dallas, TX (US); R. Barry Holtz, Houston, TX (US); Paul Winberg, Hot Springs Village, AR (US)

(73) Assignees: ILLUMITEX, INC., Austin, TX (US); G-CON, LLC, College Station, TX (US)

(21) Appl. No.: 13/294,535

(22) Filed: Nov. 11, 2011

Related U.S. Application Data
(60) Provisional application No. 61/413,262, filed on Nov. 12, 2010.

(51) Int. Cl. A01G 1/00; F21V 31/00; F21V 21/088; F21V 29/00; F21V 21/005

(52) U.S. Cl. 47/58.1 LS; 362/218

(57) ABSTRACT

A light weight and modular light emitting diode (LED) light bar comprising an extruded aluminum LED fixture frame with integral cooling fins is disclosed herein. The light bar of the present invention is used for high density multi-layer hydroponic grow facilities to greatly improve the uniformity and intensity of light distribution over the plants and at a much reduced energy cost and less heat-to-space compared to conventional lighting used in grow rooms.

### CROSS-REFERENCE TO RELATED APPLICATIONS

This application is a non-provisional application of U.S. Provisional Patent Application Ser. No. 61/413,262 filed on Nov. 12, 2010 and entitled “LIGHT-EMITTING DIODE (LED) LIGHT BAR” the entire contents of which is incorporated herein by reference.

### STATEMENT OF FEDERALLY FUNDED RESEARCH

This invention was made with U.S. Government support under Contract No. HR0011-10-3-0003 awarded by the Defense Advanced Research Projects Agency (DARPA). The government has certain rights in this invention.

### TECHNICAL FIELD OF THE INVENTION

The present invention relates in general to the field of light fixtures, and more particularly, to the design an extruded LED fixture frame comprising LED arrays for use in plant growth chambers.

### INCORPORATION-BY-REFERENCE OF MATERIALS FILED ON COMPACT DISC

None.

### REFERENCE OF A SEQUENCE LISTING

None.

### BACKGROUND OF THE INVENTION

Without limiting the scope of the invention, its background is described in connection with LED fixtures for plant growth chambers.

U.S. Patent Application Publication No. 2010/0259190 (Aikala, 2010) discloses a lighting fixture for facilitating plant growth and a light emitting component. The fixture comprises a single light emission source LED device which provides at least two emission peaks in the wavelength range of 300-800 nm and at least one of the emission peaks has Full Width of Half Maximum (FWHM) at least 50 nm or higher. The emission peaks of the LED match well with a plant photosynthesis response spectrum and is therefore particularly suitable for high efficiency artificial lighting

U.S. Patent Application Publication No. 2008/0164824 (Imberti et al., 2008) relates to a light fixture includes a plurality of fluorescent bulbs wherein a light intensity of each of the plurality of fluorescent bulbs is related to the operating temperature of the fluorescent bulbs, a sensor for sensing a physical parameter related to the light intensity, and a circuit adapted for monitoring the sensor and controlling the operating temperature of the fluorescent bulbs to maintain the operating temperature of the fluorescent bulbs within a range having a lower temperature and an upper temperature. A method of maintaining light intensity of fluorescent bulbs in an environmental chamber includes monitoring a physical parameter associated with the light intensity of the fluorescent bulbs in an environmental chamber and adjusting temperature of the fluorescent bulbs in the environmental chamber to maintain an optimum light intensity of the fluorescent bulbs in the environmental chamber.

WIPO Patent Application Publication No. WO/2009/074602 (Dekker, 2009) provides a lighting system comprising a plurality of LED light sources in heat conductive contact with an aqueous cooling liquid. The lighting system comprises a method for inhibiting algae growth in the aqueous cooling liquid. The lighting system is particularly suitable for lighting a greenhouse. The cooling liquid keeps the surface temperature of the LED light sources low enough to allow them to be positioned close to the plants being grown in the greenhouse, thus providing considerable space savings.

### SUMMARY OF THE INVENTION

The present invention describes a light emitting diode (LED) light bar comprising an extruded aluminum LED fixture frame with integral cooling fins for use in high density multi-layer hydroponic grow facilities to greatly improve the uniformity and intensity of light distribution over the plants.

The light fixture as described in one embodiment of the present invention comprises: a channel having an inner chamber, the inner chamber comprising a bottom surface and two vertical surfaces, and an outer surface opposite the bottom surface, wherein the channel further comprises at least one heat sink extending from the outer surface of the channel and one or more light emitting diode (LED) lights or LED arrays positioned in the channel on the bottom surface. In one aspect the channel is made of aluminum. In another aspect one or more light beams originating from the fixture spreads in an acute angle of illumination. In another aspect the LED lights or the LED array limit the acute angle of illumination of the one or more light beams. In yet another aspect the one or more light beams exhibit a light intensity range of 50 to 250 Photosynthesis Photon Flux (PPF) depending on a density of the LED lights or the LED array and a spacing between one or more light fixtures.

In one aspect one or more adjustable support clamps are connected to the outer surface of the channel. In another aspect the one or more adjustable support clamps are connected to a grow rack structure. In yet another aspect the channel is multi-layered onto a support frame and comprises one or more watertight materials. In one aspect the light fixture further comprises one or more attached fittings to separate the fixture from the support frame thereby dissipating heat by improving flow of air along the fixture. In one aspect the one or more attached fittings comprise plated sheet-metal. In another aspect the one or more attached fittings have a thin profile.

In another embodiment the instant invention discloses a device for plant growth, comprising: a light fixture comprising: (i) a channel having an inner chamber, the inner chamber comprising a bottom surface and two vertical surfaces, and an outer surface opposite the bottom surface, wherein the channel further comprises at least one heat sink extending from the outer surface of the channel, (ii) one or light emitting diode (LED) lights or LED arrays positioned in the channel on the bottom surface, (iii) one or more attached fittings extending from the outer surface of the light fixture, and (iv) one or more adjustable support clamps connected to the outer surface of the channel, wherein each of the one or more adjustable support clamps attached to the one or more attached fittings for attaching the light fixture to a frame, wherein the frame comprises: one or more racks supported by the one or more adjustable support clamps. In one aspect the frame is a heat sink and is made of aluminum. In another aspect the one or more attached fittings are heat dissipating fins, wherein the fins dissipate heat by improving flow of air along the light fixture. In yet another aspect the one or more adjustable support clamps are connected to a grow rack structure.

In yet another embodiment the present invention provides a method of promoting plant growth in a growth chamber, a greenhouse, a grow room or combinations thereof comprising the steps of: providing one or more grow rack structures comprising a medium for a germination and growth of the plant, wherein the medium comprises one or more plant seeds, plant saplings or a combination in soil, water, a growth medium, a nutrient medium or combinations or modifications thereof, providing a light fixture comprising: (i) a channel having an inner chamber, the inner chamber comprising a bottom surface and two vertical surfaces, and an outer surface opposite the bottom surface, wherein the channel further comprises at least one heat sink extending from the outer surface of the channel, (ii) one or light emitting diode (LED) lights or LED arrays positioned in the channel on the bottom surface, (iii) one or more attached fittings extending from the outer surface of the light fixture, and (iv) one or more adjustable support clamps connected to the outer surface of the channel, wherein each of the one or more adjustable support clamps attached to the one or more attached fittings for attaching the light fixture to a frame, wherein the frame comprises: the one or more grow rack structures supported by the one or more adjustable support clamps, operating the light fixture device to illuminate the one or more grow rack structures with one or more light beams at a controlled light intensity and for a specified time duration, wherein the light beams are spread at an acute angle of illumination, and providing water, nutrients, fertilizers and other suitable growth factors periodically to the grow rack structures to promote the growth of the plant.

In one aspect the channel is made of aluminum. In another aspect the one or more light beams exhibit a light intensity range of 50 to 250 Photosynthesis Photon Flux (PPF) depending on a density of the LED lights or the LED array and a spacing between one or more light fixtures. In yet another aspect the channel is made of aluminum. In another aspect the one or more attached fittings are heat dissipating fins, wherein the fins dissipate heat by improving flow of air along the light fixture. In related aspects the frame is a heat sink and is made of aluminum. In another aspect the channel comprises watertight materials.

### BRIEF DESCRIPTION OF THE DRAWINGS

For a more complete understanding of the features and advantages of the present invention, reference is now made to the detailed description of the invention along with the accompanying figures and in which:

FIG. 1A is a schematic showing the light emitting diode (LED) light bar of the present invention;

FIG. 1B is a schematic showing an expanded isometric view the highlighted region 120 in FIG. 1A; and

FIG. 2 is a schematic of the LED light bar of the present invention showing the end connection details at both ends.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not limit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not limit the invention, except as outlined in the claims.

As used herein and in the appended claims, the term “light-emitting diode (LED)” includes LED's of all types, such as light-emitting polymers, semiconductor dies that produce light in response to current, organic LED's, electro-luminescent strips, silicon-based structures that emit light, etc. The term may also refer to a single LED package having multiple semiconductor dies that are either individually or collectively controlled. In addition, a LED may also refer to a packaged or a non-packaged LED's, surface-mount LED's, chip on board LED's, etc.

The term “fixture” as used herein includes any structure that is to be suspended from the ceiling. The term “aluminum” as used herein and in the appended claims includes pure aluminum and aluminum alloys.

As used herein the term “clamps” refer to a variety of different devices, for example pipe clamps, cable clamps, electrical fittings, saddles, brackets, spring bolts, beam clamps, roller clamps, and variable angle support legs.

The term “sheet metal” as used herein refers to any part that can be cut (e.g., a stamping operation) from a metal blank whose thickness is less than 20% of its width and height. The term typically refers to metal plates (heavy metal plate) having a thickness range of 0.5 to 8.00 inches.

The present invention discloses a light emitting diode (LED) light bar comprising an extruded aluminum LED fixture frame with integral cooling fins. The light weight, very modular light bar of the present invention is used for high density multi-layer hydroponic grow facilities to greatly improve the uniformity and intensity of light distribution over the plants and at a much reduced energy cost and less heat-to-space compared to conventional lighting used in grow rooms.

The IP65 low-voltage hoseproof rated light bar of the instant invention has integral adjustable support clamps on each end and is easy to connect to grow the rack structure. The fixture allows for a 66% reduction in power consumption compared to standard T5HO fluorescent lighting currently in use as industry standard.

The heat-to-space rating of the light bar disclosed herein is superior to other fixtures because the aluminum acts as a heat sink and provides exceptional heat dissipation abilities. The ease of connection allows for portability. The lights are positioned under a top rack or support to direct straight down onto plants below. The Leeds positioned on rack may be adjusted to provide highly directed light, or more spread-out light, depending on height of fixture from rack.

The low-profile aluminum bar with heat dissipating fins, the ease of installation, the low mass, the “plug and-play” ability and the hose proof voltage are some of the unique features of the invention as described hereinabove.

The present inventors have run pilot-scale grow tests with arrays of LED's on the aluminum bars of the present invention on pilot-scale test racks in plant growth chambers. The invention could be commercially useful for high-density, multi-level, hydroponic, soil or other substrate-based grow rooms utilizing multi-level, high bays.

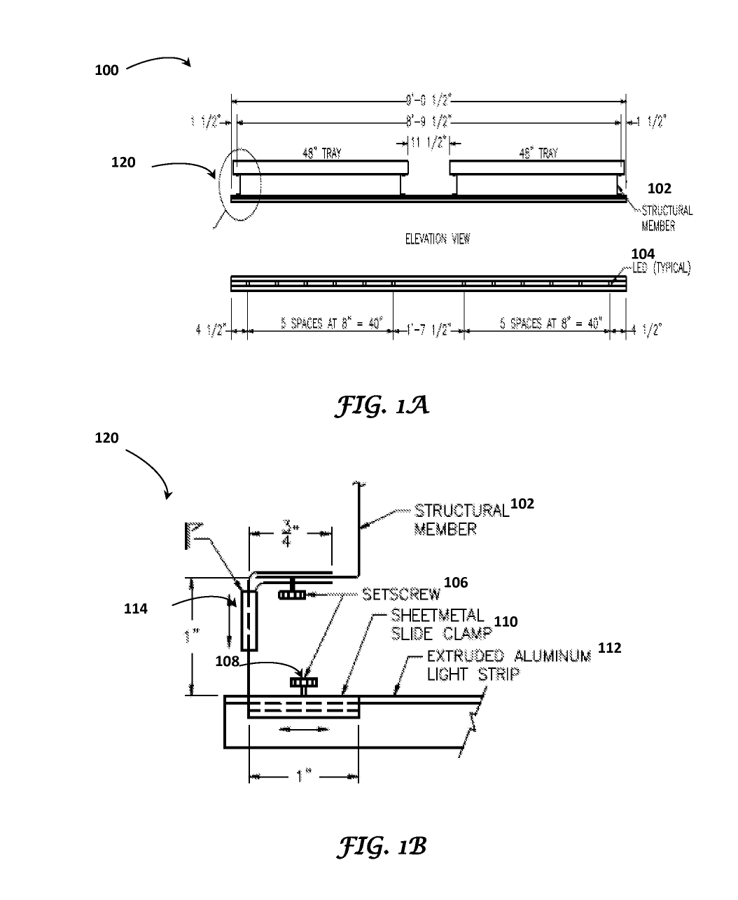

FIG. 1A is a schematic showing the light emitting diode (LED) light bar 100 of the present invention. FIG. 1A provides an elevation view with the LRD lights or LED array 104 attached to a structural member 102. The end of the light bar 104 showing how it connects to structure 102 is highlighted (120). An expanded view of this connecting region 120 is shown in FIG. 1B and it comprises two set screws 106 and 108 attached to the structural member 102 and the extruded aluminum strip 112, respectively. The aluminum strip 112 is attached to the structural member 102 by the use of a sheet-metal side clamp 110, via an attachment 114.

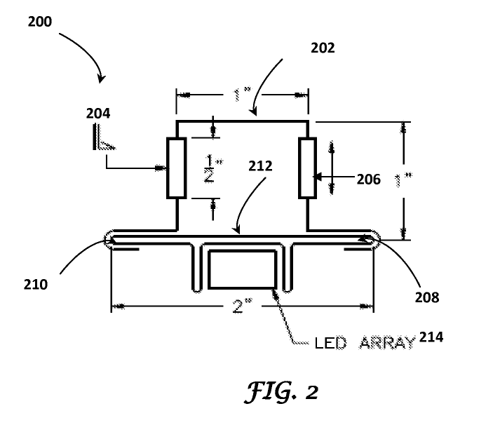

FIG. 2 is a schematic of the LED light bar 200 of the present invention showing the end connection details at both ends. The light bar 212 is connected to a structural member 202 by fittings 204 and 206 at the ends 210 and 208, respectively. The light bar 212 has one or more LED arrays 214 as indicated in the figure.

Some unique advantages realized by using the light bar of the present invention over other existing products include: (i) greatly improved uniformity and intensity of light distribution over the plants and at a much reduced energy cost and less heat-to-space compared to conventional lighting used in grow rooms, (ii) better heat dissipation to the space cooling system because of the thin profile of the fixture, (iii) the focused light beam allows the fixtures to be mounted close to the plants, creating very little light spill-over with the half-On/half-Off grow lighting control schedule, (iv) greater number and variety in the type of plants that can be grown (for e.g., N. Benthamiana an ideal source of biomass for vaccine products), and (v) a better light intensity range: 50-250 Photosynthesis Photon Flux (PPF) depending on a LED light or LED array density (number of LED arrays or number of LED's per light bar or fixture) and a spacing between light bars.

It is contemplated that any embodiment discussed in this specification can be implemented with respect to any method, kit, reagent or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C or combinations thereof” is intended to include at least one of: A, B, C, AB, AC, BC or ABC, and if order is important in a particular context, also BA, CA, CB, CBA, BCA, ACB, BAC or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

### REFERENCES

U.S. Patent Application No. 2010/0259190: Lighting Assembly.
U.S. Patent Application No. 2008/0164824: Temperature Controlled Light Fixture for Environmental Chamber.
WIPO Patent Application No. WO/2009/074602: LED Lighting System Cooled With Aqueous Liquid, In Particular For Greenhouses.

What is claimed is:

1. A light fixture, comprising:
a channel having an inner chamber, the inner chamber comprising a bottom surface and two vertical surfaces, and an outer surface opposite the bottom surface, wherein the channel further comprises at least one heat sink extending from the outer surface of the channel; and
one or more light emitting diode (LED) lights or LED arrays positioned in the channel on the bottom surface.

2. The light fixture of claim 1, wherein the channel is made of aluminum.

3. The light fixture of claim 1, wherein one or more light beams originating from the fixture spreads in an acute angle of illumination.

4. The light fixture of claim 3, wherein the LED lights or the LED array limit the acute angle of illumination of the one or more light beams.

5. The light fixture of claim 1, wherein the one or more light beams exhibit a light intensity range of 50 to 250 Photosynthesis Photon Flux (PPF) depending on a density of the LED lights or the LED array and a spacing between one or more light fixtures.

6. The light fixture of claim 1, wherein one or more adjustable support clamps are connected to the outer surface of the channel.

7. The light fixture of claim 6, wherein the one or more adjustable support clamps are connected to a grow rack structure.

8. The light fixture of claim 1, wherein the channel is multi-layered onto a support frame.

9. The light fixture of claim 1, wherein the channel comprises one or more watertight materials.

10. The light fixture of claim 1, further comprising one or more attached fittings to separate the fixture from the support frame thereby dissipating heat by improving flow of air along the fixture.

11. The light fixture of claim 10, wherein the one or more attached fittings comprise plated sheet-metal.

12. The light fixture of claim 10, wherein the one or more attached fittings have a thin profile.

13. A device for plant growth, comprising:
a light fixture comprising:
a channel having an inner chamber, the inner chamber comprising a bottom surface and two vertical surfaces, and an outer surface opposite the bottom surface, wherein the channel further comprises at least one heat sink extending from the outer surface of the channel;
one or light emitting diode (LED) lights or LED arrays positioned in the channel on the bottom surface;
one or more attached fittings extending from the outer surface of the light fixture; and
one or more adjustable support clamps connected to the outer surface of the channel, wherein each of the one or more adjustable support clamps attached to the one or more attached fittings for attaching the light fixture to a frame, wherein the frame comprises:
one or more racks supported by the one or more adjustable support clamps.

14. The device of claim 13, wherein the frame is a heat sink.

15. The device of claim 13, wherein the frame is made of aluminum.

16. The device of claim 13, wherein the one or more attached fittings are heat dissipating fins, wherein the fins dissipate heat by improving flow of air along the light fixture.

17. The device of claim 13, wherein the one or more adjustable support clamps are connected to a grow rack structure.

18. A method of promoting plant growth in a growth chamber, a greenhouse, a grow room or combinations thereof comprising the steps of:
providing one or more grow rack structures comprising a medium for a germination and growth of the plant, wherein the medium comprises one or more plant seeds, plant saplings or a combination in soil, water, a growth medium, a nutrient medium or combinations or modifications thereof;
providing a light fixture comprising:
a channel having an inner chamber, the inner chamber comprising a bottom surface and two vertical surfaces, and an outer surface opposite the bottom surface, wherein the channel further comprises at least one heat sink extending from the outer surface of the channel;
one or light emitting diode (LED) lights or LED arrays positioned in the channel on the bottom surface;
one or more attached fittings extending from the outer surface of the light fixture; and
one or more adjustable support clamps connected to the outer surface of the channel, wherein each of the one or more adjustable support clamps attached to the one or more attached fittings for attaching the light fixture to a frame, wherein the frame comprises: the one or more grow rack structures supported by the one or more adjustable support clamps;
operating the light fixture device to illuminate the one or more grow rack structures with one or more light beams at a controlled light intensity and for a specified time duration, wherein the light beams are spread at an acute angle of illumination; and
providing water, nutrients, fertilizers and other suitable growth factors periodically to the grow rack structures to promote the growth of the plant.

19. The method of claim 18, wherein the channel is made of aluminum.

20. The method of claim 18, wherein the one or more light beams exhibit a light intensity range of 50 to 250 Photosynthesis Photon Flux (PPF) depending on a density of the LED lights or the LED array and a spacing between one or more light fixtures.

21. The method of claim 18, wherein the channel is made of aluminum.

22. The method of claim 18, wherein the one or more attached fittings are heat dissipating fins, wherein the fins dissipate heat by improving flow of air along the light fixture.

23. The method of claim 18, wherein the frame is a heat sink.

24. The method of claim 18, wherein the frame is made of aluminum.

25. The method of claim 18, wherein the channel comprises watertight materials.
